(19) United States
(12) Patent Application Publication
(10) Pub. No.: US 2015/0169643 A1
(43) Pub. Date: Jun. 18, 2015

(54) PROVIDING SUPPLEMENTAL SEARCH RESULTS IN REPSONSE TO USER INTEREST SIGNAL

(71) Applicants: David Kogan, Natick, MA (US); Nathan D. Beach, Sunnyvale, CA (US); George A. Madrid, Arlington, MA (US); Rachel J. Grey, Somerville, MA (US); Arthur E. Blume, Melrose, MA (US); David A. Charlton, Medford, MA (US); George M. N. Ruban, Somerville, MA (US); Diego Ariel Gertzenstein, Sudbury, MA (US); Francis E. Marino, JR., Boston, MA (US); Kenneth W. Dauber, Palo Alto, CA (US); Hilary B. Hutchinson, Hingham, MA (US); Robert E. Lewis, Tewksbury, MA (US); David Black, Mountain View, CA (US); Andrew J. Martone, San Francisco, CA (US)

(72) Inventors: David Kogan, Natick, MA (US); Nathan D. Beach, Sunnyvale, CA (US); George A. Madrid, Arlington, MA (US); Rachel J. Grey, Somerville, MA (US); Arthur E. Blume, Melrose, MA (US); David A. Charlton, Medford, MA (US); George M. N. Ruban, Somerville, MA (US); Diego Ariel Gertzenstein, Sudbury, MA (US); Francis E. Marino, JR., Boston, MA (US); Kenneth W. Dauber, Palo Alto, CA (US); Hilary B. Hutchinson, Hingham, MA (US); Robert E. Lewis, Tewksbury, MA (US); David Black, Mountain View, CA (US); Andrew J. Martone, San Francisco, CA (US)

(73) Assignee: GOOGLE INC., Mountain View, CA (US)

(21) Appl. No.: 13/470,707

(22) Filed: May 14, 2012

(51) Int. Cl. G06F 17/30

(52) U.S. Cl. CPC G06F 17/30277; G06F 17/30554

(57) ABSTRACT

Methods, systems, and apparatus, including computer program products, for processing search results. A first query suggestion for a search query input is received, and a first set of image search results responsive to the query suggestion is received. Both are provided to a user device in response to the search query input. After providing the first set of image search results to the user device, a signal of user interest is detected in either of the query suggestion or at least one of the image search results. The detection is prior to receiving another search query input subsequent to the search query input. In response to the detection, a second set of image search results is provided to the user device to supplement the first set of image search results previously provided to the user device. The second set of image search results are responsive to the query suggestion.

### BACKGROUND

This specification describes technologies relating to search results processing.

The Internet provides access to a wide variety of resources, for example, video files, image files, audio files, or Web pages. Search engines are used to search these resources. For example, digital images that satisfy a user's informational need can be identified by a search engine in response to receiving a search query. A search query is data that a user submits to a search engine to satisfy the user's informational needs. The search queries are usually in the form of text, e.g., one or more query terms. The search system selects and scores resources based on their relevance to the search query and on their importance or quality relative to other resources and provides search results that link to the selected resources. The search results are typically ordered according to the scores and presented according to this order.

### SUMMARY

This specification describes technologies relating to providing supplemental search results in response to user interest signals.

In general, one aspect of the subject matter described in this specification can be embodied in methods that include the actions of receiving, from a user device, a first search query input comprising one or more characters: receiving a first query suggestion from a query suggestion service, the first query suggestion having been generated based on the first search query input and being different from the first search query input; receiving a first set of image search results, each of the image search results referencing an image responsive to the first query suggestion; providing the first set of the image search results and the first query suggestion to the user device in response to the first search query input; after providing the first set of image search results to the user device, detecting, by a computer, a signal of user interest in either of the first query suggestion or at least one image search result in the first set of image search results, the detection of the signal of user interest being prior to receiving a second search query input subsequent to the first search query input; and in response to detecting the signal of user interest, providing a second set of image search results to the user device to supplement the first set of image search results previously provided to the user device, the second set of image search results being responsive to the first query suggestion. Other embodiments of this aspect include corresponding systems, apparatus, and computer program products.

Particular embodiments of the subject matter described in this specification can be implemented so as to realize one or more of the following advantages. In the absence of a signal of user interest in either a query suggestion or search results that are provided with the query suggestion, supplemental search results responsive to the query suggestion are not provided to a user device. This selective provisioning of supplemental search results facilitates a balance between providing a user enough search results to determine whether the search results satisfy the user's informational need and providing a larger set of search results that a user can view to better make this determination. Providing an initial set of search results and conditioning the provisioning of a second set of search results to supplement the initial set of search results also addresses the technical problem of conserving serving resources when providing search results responsive to query suggestions that are not initially selected by a user.

In some implementations, a third set of search results that supplements the first and second sets of search results is provided only in response to an explicit user request. At the search engine server, the first and second sets are determined in a first search operation, and the first set is provided while the second set is cached. However, the third set of search results is not determined until the explicit user request is received. This conserves system resources while maintaining a relatively high cache hit rate as compared to initially caching the first, second and third sets of search results.

Each of the advantages above is optional and can be achieved separately or in combination.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment in which a search engine provides search services.

FIG. 2 is a timing diagram of an example process for providing supplemental search results to a user device.

FIGS. 3A-3C depict a web search page displaying query suggestions and search results responsive one of the query suggestions.

FIG. 4 is a flow diagram of an example process for providing supplemental search results to a user device.

### DETAILED DESCRIPTION

### 1.0 Overview

Search systems can provide search suggestions to users to help users satisfy their informational needs. As used herein, the term “query suggestion” is a suggested data for a query that can be used to refine a search or refine a search strategy. Some search systems provide query suggestions in the form of a list of query suggestions as the user is typing a query. The user can select one of the query suggestions from the list without having to type the entire query suggestion. A user device typically sends inputs to a search engine with each keystroke, and the search engine provides the query suggestions with prefixes that match the entered characters. Once received, the user device displays these suggestions for user selection.

This specification describes technologies relating to providing sets of search results in response to a query suggestion. In response to first search query input of one or more characters, a search engine receives a first query suggestion generated based on the first search query input, and a first set of image search results. The query suggestion is different from the first search query input, and each of the search results is responsive to the first query suggestion. The search engine provides the first set of image search results and the query suggestion to the user device for display on the user device. After providing the first set of image search results to the user device, the search engine monitors for a signal of user interest in either of the first query suggestion or at least one image search result in the first set of image search results. If the signal of user interest is received from the user device prior to receiving a second search query input subsequent to the first search query input, then the search engine provides a second set of image search results to the user device to supplement the first set of image search results previously provided to the user device. Like the first set of image search results, the second set of image search results is made up of search results responsive to the first query suggestion.

In some implementations, the search engine provides a third set of image search results responsive to the query suggestion in response to an explicit user request for additional search results. In variations of these implementations, the cardinality of the first set of search results is less than the cardinality of the second set of search results, and the cardinality of the second set of search results is less than the cardinality of the third set of search results.

In some implementations, second sets of image search results can be sent sequentially. After providing the second set of image search results (whether the initial second set or a subsequent second set), the search engine again monitors for a signal of user interest. If the signal of user interest is received from the user device prior to receiving another search query input subsequent to the most recent query input, then the search engine provides a subsequent second set of image search results to the user device to supplement sets image search results previously provided to the user device.

### 1.1 Example Environment

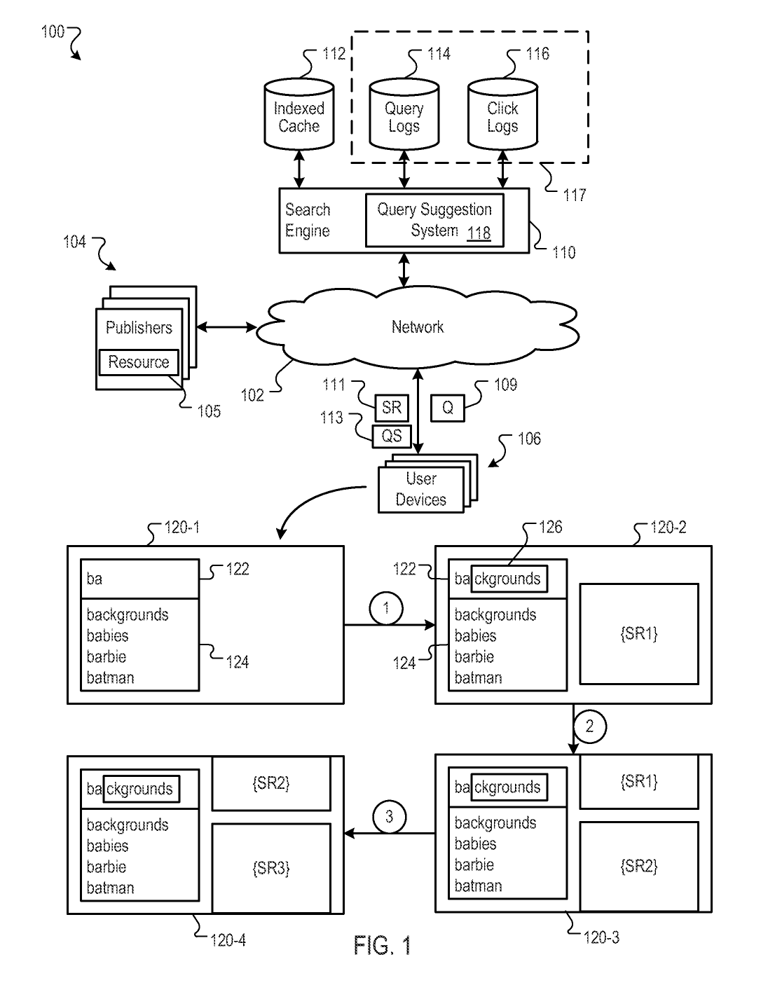

FIG. 1 is a block diagram of an example environment 100 in which a search engine 110 provides search services. A computer network 102, such as a local area network (LAN), wide area network (WAN), the Internet, or a combination thereof, connects publisher web sites 104, user devices 106, and the search engine 110. The online environment 100 may include many thousands of publisher web sites 104 and user devices 106.

A web site 104 is a one or more web page resources 105 associated with a domain name, and each web site is hosted by one or more servers. An example web site is a collection of web pages formatted in hypertext markup language (HTML) that can contain text, graphic images, multimedia content, and programming elements, such as scripts. Each web site 104 is maintained by a publisher, e.g., an entity that manages and/or owns the web site.

A resource is any data that can be provided by the publisher 104 over the network 102 and that is associated with a resource address. Resources include HTML pages, word processing documents, and portable document format (PDF) documents, images, video, and feed sources, to name just a few. The resources can include content, such as images, text, videos, and so on, and may include embedded information (such as meta information and hyperlinks) and/or embedded instructions (such as scripts).

A user device 106 is an electronic device that is under the control of a user and is capable of requesting and receiving resources over the network 102. Example user devices 106 include personal computers, mobile communication devices, and other devices that can send and receive data over the network 102. A user device 106 typically includes a user application, such as a web browser, to facilitate the sending and receiving of data over the network 102. The web browser can enable a user to display and interact with text, images, videos, music and other information typically located on a web page at a website on the World Wide Web or a local area network.

To facilitate searching of these resources 105, the search engine 110 identifies the resources by crawling the publisher web sites 104 and indexing the resources provided by the publisher web sites 104. The indexed and, optionally, cached copies of the resources are stored in an indexed cache 112.

The user devices 106 submit search queries 109 to the search engine 110. The search queries 109 are submitted in the form of a search input and, optionally, a unique identifier that identifies the user device 106 that submits the request. The unique identifier can be data from a cookie stored at the user device, or a user account identifier if the user maintains an account with the search engine 110, or some other identifier that identifies the user device 106 or the user using the user device.

In response to the search request, the search engine 110 uses the indexed cache 112 to identify resources that are relevant to the queries. The search engine 110 identifies the resources in the form of search results 111 and returns the search results to the user devices 106 in search results page resources. A search result is data generated by the search engine 110 that identifies a resource that satisfies a particular search query, and includes a resource locator for the resource. An example search result can include a web page title, a snippet of text extracted from the web page and/or a thumbnail of an image included in the web page, and the URL of the web page.

The search results are ranked based on scores related to the resources identified by the search results, such as information retrieval (“IR”) scores, a quality score of the resource derived from one or more of a selection rate of search results that reference the resource, an authority score of the resource in the context of references to other resources, and other search related measurements. The ranking of the search results is based on these scores. The search results are ordered according to these scores and provided to the user device according to the order.

The user devices 106 receive the search results pages and render the pages for presentation to users. In response to a user selecting a search result at a user device 106, the user device 106 requests the resource identified by the resource locator included in the selected search result. The publisher of the web site 104 hosting the resource receives the request for the resource from the user device 106 and provides the resource to the requesting user device 106.

In some implementations, the queries 109 submitted from user devices 106 are stored in query logs 114. Click data for the queries and the web pages referenced by the search results are stored in click logs 116. The query logs 114 and the click logs 116 define search history data 117 that include data from and related to previous search requests associated with unique identifiers. The click logs define actions taken responsive to search results provided by the search engine 110. The query logs 114 and click logs 116 can be used to map queries submitted by the user devices to web pages and images that were identified in search results and the actions taken by users (e.g., that data are associated with the identifiers from the search requests so that a search history for each identifier can be accessed). The click logs 116 and query logs 114 can thus be used by the search engine to determine the sequence of queries submitted by the user devices, the actions taken in response to the queries, and how often the queries are submitted. In some implementations, the click logs 116 and query logs 114 are anonymized.

### 1.2 Query Suggestions

In addition to providing search results 111 in response to queries 109, the search engine 110, by use of a query suggestion system 118, provides query suggestions 113 to the user devices. The query suggestions 113 can be provided by the search engine 110 in response to a query input from the user device. Most often each query suggestion is different from the query input, as the query suggestions are completion suggestions for a partial query. As used herein, a “partial query” is a query input that can be completed to form a completed query of one or more words. A partial query can thus be one or more keyboard inputs that define a prefix or stem of a word, or can also be an entire word or words. For example, the letter “a” is a partial query, as the letter “a” is the stem for the words “aardvark,” “Appalachia,” etc. The partial query itself can also be a word, such as the letter “a” is a word. Likewise, the word “New” is also a partial query, as it can be combined with “York”, “London”, etc., to form other queries, and the partial query “New York” can be combined with “Mets” or “Yankees” to form other queries.

The query suggestion system 118 accesses the search history data 117 and determines a list of query suggestions based on search queries that have the query characters as a stem (or, alternatively or in addition, queries that are related by topic or co-occurrence). In some implementations, the query suggestions are based on search history data 117 associated with the unique identifier of the user device that submitted the query input. For example, the query suggestions can be suggestions based on frequency of co-occurrence and query stemming of queries stored in query logs 114, and then filtered according to the particular search history data 117 associated with the unique identifier.

To illustrate, assume a user device requests a search resource (e.g., a search engine web page) from the search engine 110. The search engine 110 provides the requested search resource and interface instructions to the user device. The search resource and interface instructions cause the user device to generate a search interface 120 that includes a query input field 122, as depicted in the user interface 120-1 of FIG. 1. For example, the user device can launch a web browser and request a web, an image, or a video search page from the search engine 110.

The query input field 122 can receive query characters from a user, e.g., keystroke inputs, and provides each input to the search engine 110 in the form of a query input. In response to the query input, the query suggestion system 118 identifies and ranks query suggestions according to an order from highest rank to a lowest rank, and provides the user device with the query suggestions 113. For example, for the query input “ba,” the query suggestion system 118 can access the search history data 117 and determine query suggestions based on search queries that have the query characters “ba” as a query stem, e.g., “backgrounds,” “babies,” “barbie,” “batman,” etc.

Various ranking algorithms can be used. In some implementations, the query suggestions are ranked based on the probability of the query suggestion being selected by a user. In some implementations, the query suggestion with the highest rank is the shortest word with the highest probability of being selected by the user. In some implementations, the query suggestions are ranked or re-ranked so natural extensions are shown and grouped together.

The user device receives the query suggestions 113 and renders the query suggestions according to an order. The query suggestions can be presented in a query suggestion box 124 according to an order from a highest rank to a lowest rank. For example, the user device can present the query suggestions in the query suggestion box 124 in the search interface 120. The query suggestions are presented in the query suggestion box 124 such that the first query suggestion (e.g., “backgrounds”) has the highest probability of being selected by a user, the second query suggestion (e.g., “babies”) has the second highest probability, and so on.

### 1.3 Search Results for Query Suggestions

In some implementations, the search engine 110 provides with the query suggestions a first set of image search results that are responsive to the query suggestions. For example, the search system 110 provides a first set of search result {SR1} that are responsive to the highest ranked query suggestion “backgrounds”, as represented in the user interface 120-2 of FIG. 1.

When search results responsive to a query suggestion are displayed, the user device generates an indication in the search interface that indicates the query suggestion for which the results are responsive. In some implementations, the indication can be an automatic completion of a query input in the query input field 122 indicating the query suggestion for which the search results are responsive. The automatic completion includes differentiated text 126 appended to the query input in the query input field 122. For example, the differentiated text in the query input field 122 can be presented with a gray scale background. In some implementations, the differentiated text 126 has a color background. In some implementations, the font of the differentiated text 126 can have a different font than the query input, e.g., bold, italics, font type, etc. The cursor in the text input field, however, remains at the last actual input, i.e., after the letter “a” in the query input “ba”, so that the user may resume or continue typing to add to the query input “ba”.

After providing the first set of image search results {SR1} to the user device, the search engine 110 monitors for a signal of user interest in either of the first query suggestion or at least one image search result in the first set of image search results {SR1}. When the detection of the signal of user interest occurs prior to receiving a second search query input subsequent to the first search query input, the search engine 110 then provides a second set of image search results {SR2} to the user device to supplement the first set of image search results {SR1}previously provided to the user device. The second set of image search results {SR2} is also responsive to the first query suggestion.

The detection of the signal of user interest can be done in a variety of different ways. In some implementations, the user device 106 may send user interaction data describing user interactions in the search interface 120 to the search engine 110. For example, the user interaction data may describe a movement of a cursor in the viewport displaying the first set of image search results, a scrolling event that results in a scrolling of the displayed first image search results in the viewport, a non-navigating user click received in a view port in which the first image search results are displayed, or a timeout resulting from inactivity on the part of the user. Each of these events described by such data are indicative of user interest in either of the query suggestion or the image search results displayed, and each event occurs in the absence of the user continuing to input additional characters or terms in the query input field 122.

In some implementations, after providing the second set of search results {SR2}, the search engine 110 provides a third set of search results {SR3} to the user device only in response to an explicit request for the third set of search results from the user device. For example, a user may scroll down to the bottom of the page 120-3, at which there may be a request input (e.g., a button) to request additional search results. In response to receiving data from the user device indicating a selection of the request input, the search engine 110 provides the third set of search results {SR3} to the user device, as depicted in the user interface 120-4.

### 2.0 Example Timing Diagram and User Interface Examples

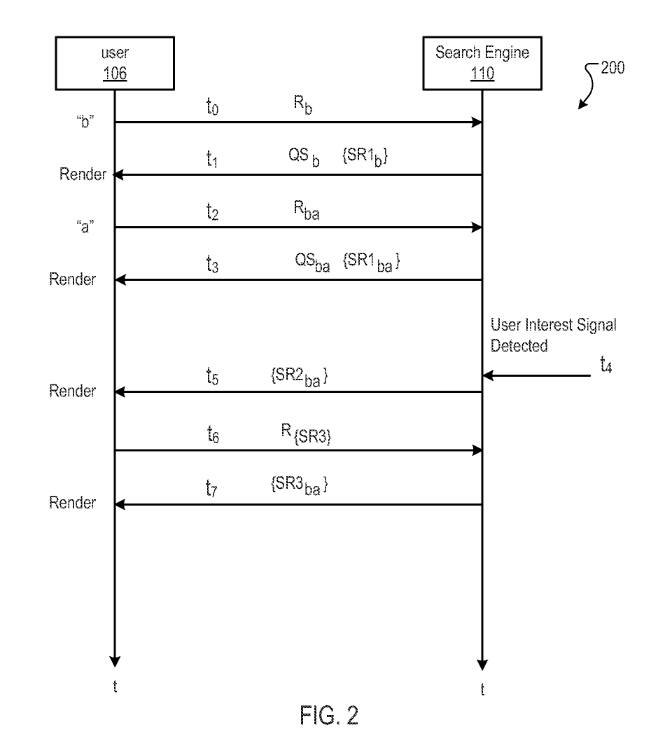

FIG. 2 is a timing diagram 200 of an example process for providing supplemental search results to a user device. The timing diagram 200 depicts a process associated with a client 106 and the search engine 110 as time elapses downward along a vertical axis t.

At a time t₀, the client 106 provides a query input R_{b} to the search engine 110 in response to receiving a query input character “b”. For example, the client 160 receives the query input character “b” from a query input field in a search interface, and transmits data to the search engine 110 indicating the query input.

The search engine 110 identifies query suggestions QS_{b} responsive to the query input R_{b}, and further determines a set of search results {SR1_{b}}. Each search result in the set of search results {SR1_{b}} is responsive to, for example, a top-ranked query suggestion in the query suggestions QS_{b}. At time t₁ the search engine 110 provides the suggestions and the search results to the client 106.

After the time t₁, the search engine 110 determines whether a signal of user interest in either of the query suggestion or at least one image search result in the set of image search results is detected prior to receiving another search query input subsequent to the first search query input. As shown in the timing diagram 200, a signal of user interest is not detected prior to time t₂, a time at which the client 106 provides a second query input R_{ba} to the search engine 110. For example, the query input field receives a second character “a” as input from a user and the combined query input of “ba” is used for the second query input R_{ba}.

Accordingly, the search engine 110 identifies query suggestions QS_{b}, responsive to the query input R_{ba}, and further determines a set of search results {SR1_{ba}}. Each search result in the set of search results {SR1_{ba}} is responsive to, for example, a top-ranked query suggestion in the first query suggestions QS_{ba}. At time t₃ the search engine 110 provides the suggestions and the search results to the client 106. Upon receipt, the user device 106 renders the suggestions and search results.

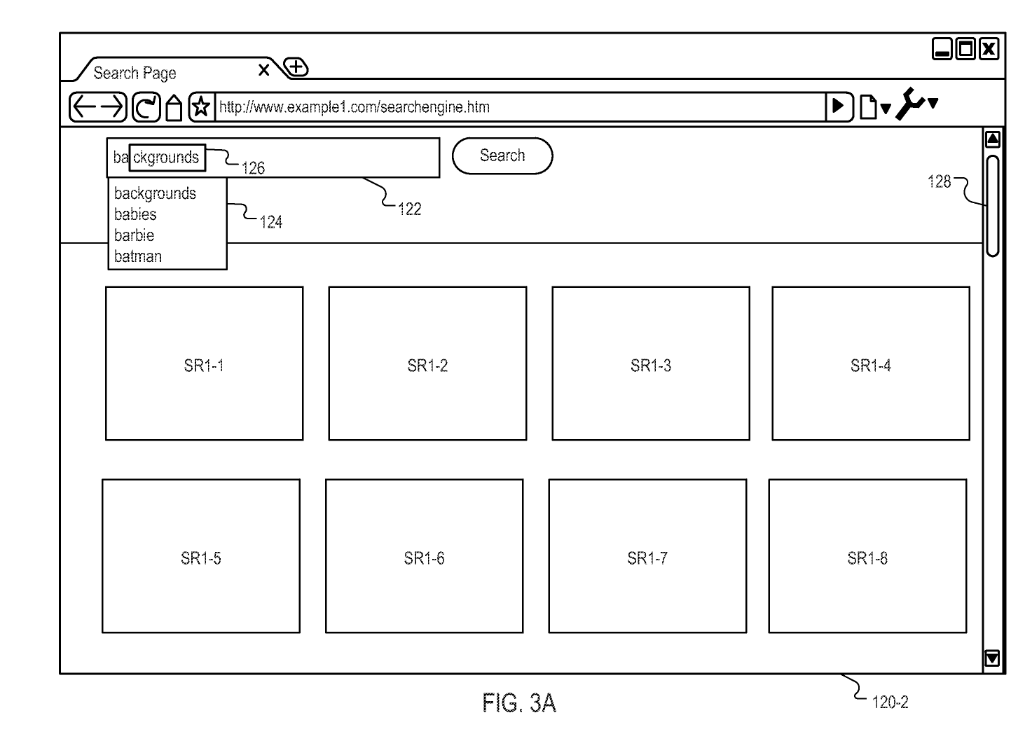

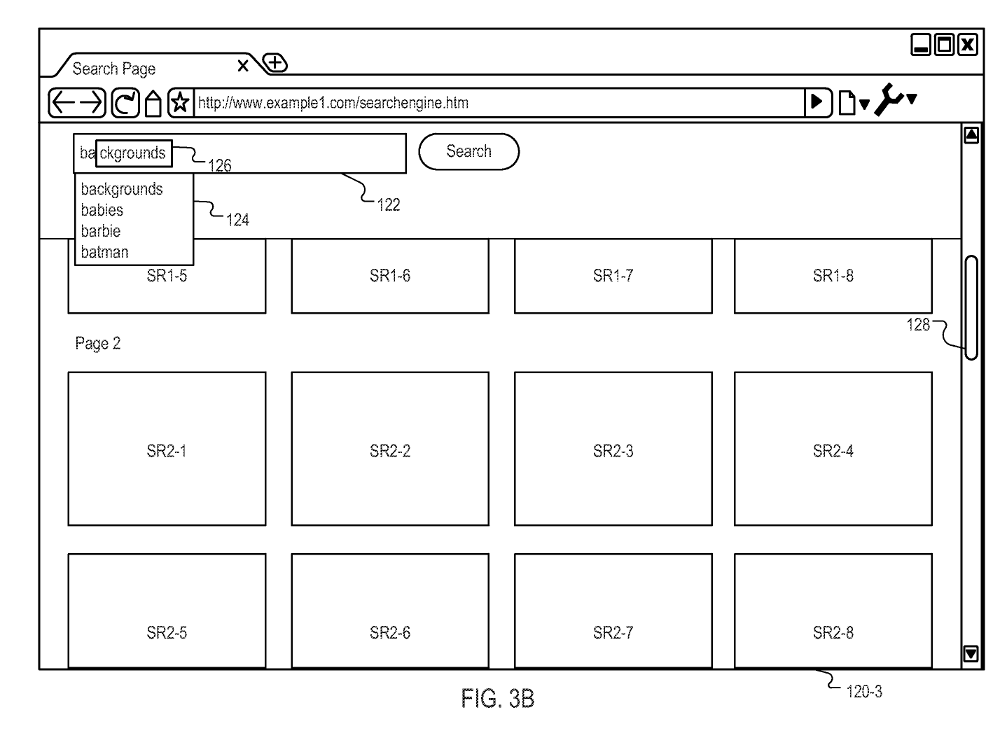

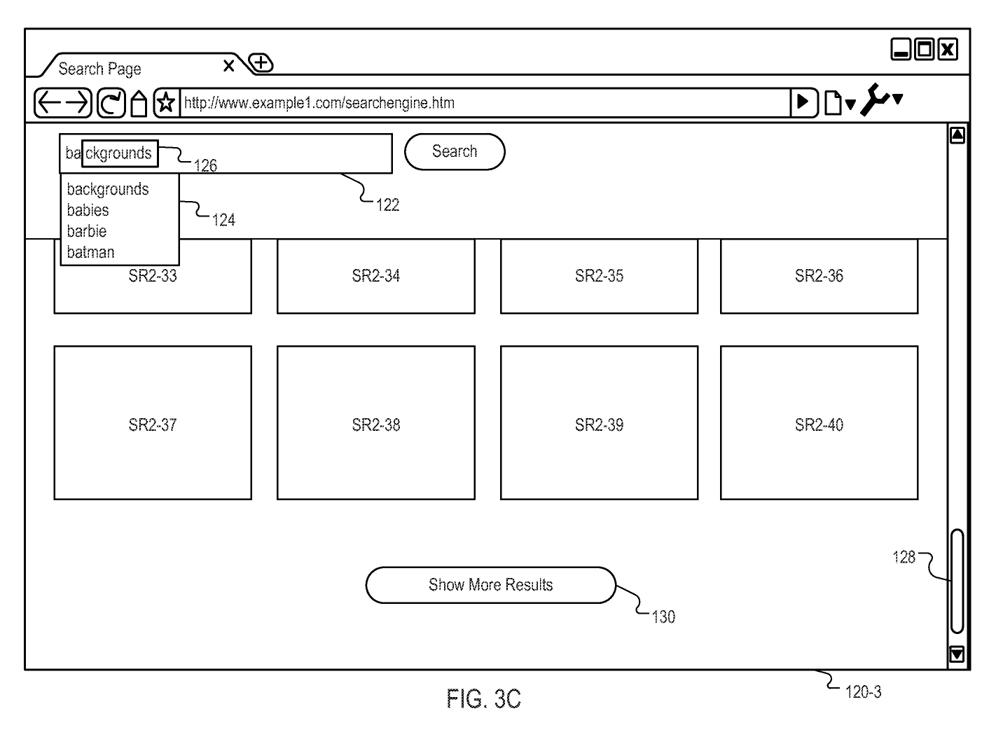

The resulting user interface 120-2 is depicted in FIG. 3A. As shown in FIG. 3A, eight search results SR1-1 . . . SR1-8, each responsive to the query suggestion “backgrounds” for the query input “ba”, form the set of search results {SR1_{ba}}. In some implementations, the number of search results in the first set of search results {SR1_{b}} are such that each search result in the first set of search results can be concurrently displayed in the available space in an active viewport of user interface 120-2. For example, the user device 106 may send, with the query input, data indicating the size of available space for presenting search results in the view port on the user device. From this data the search engine determines the size, and, in turn, determines first cardinality for the set of image search results based on the size of the available space. The search engine then selects a first cardinality of search results responsive to the first query suggestion for inclusion in the first set of search results {SR1_{ba}}.

After the time t₃, the search engine 110 determines whether a signal of user interest in either of the query suggestion or at least one image search result in the set of image search results is detected prior to receiving another search query input subsequent to the first search query input. As shown in the timing diagram 200, a signal of user interest is detected at time t₄, prior to receiving another query input. For example, as illustrated by the position of the scroll indicator 128 in FIG. 3B, the user has scrolled down on the search results user interface 120-3. In response, the search engine 110 provides a second set of search results {SR2_{ba}}. Each search result in the second set {SR2_{ba}} is responsive to the query suggestion QS_{ba}. In some implementations, each search result in the second set is responsive to the top-ranked query suggestion in the set of query suggestions QS_{ba}.

The resulting user interface 120-3, after the scrolling operation and the rendering of the second set of search results {SR2_{ba}} at time t₅, is depicted in FIG. 3B. As shown in FIG. 3B, eight new search results SR2-1 . . . SR2-8, each responsive to the query suggestion “backgrounds” for the query input “ba”, form the set of search results {SR2_{ba}}. In some implementations, the search engine 110 determines a cardinality of the second set of search results {SR2_{ba}} that is equal to the cardinality of the first set of search results {SR1_{ba}}. In other implementations, however, the cardinality of the second set of search results {SR2_{ba}} is greater than the cardinality of the first set of search results {SR1_{ba}}. For example, as shown in FIG. 3A, the cardinality of the first set is 8 (SR1-1 . . . SR1-8). However, the cardinality of the second set, as illustrated in FIG. 3C, is 40.

At the bottom of the user interface 102-3 is a user input 130. The user input 130, when selected by the user, generates a request for a third set of image search results responsive to the query suggestion. As shown in the timing diagram 200 of FIG. 2, at a time t₆, after the user device has rendered the second set of search results {SR2_{ba}}, the user requests a third set of search results {SR3}. In response, the search engine 110 provides a third set of search results {SR3_{ba}} to the user device 106 at time t₇. The cardinality of the third set of search results {SR3_{ba}} may, in some implementations, be equal to the cardinality of the first and second sets of image search results. However, in other implementations, the cardinality of the third set of search results {SR3_{ba}} may be greater than the cardinality of the second set of search results {SR2_{ba}}. Likewise, the cardinality of the second set of search results {SR2_{ba}} may be greater than the cardinality of the first set of search results {SR1_{ba}}. For example, the cardinality of the first set may be 8; the second set, 40; and the third set, 100. Other values can also be used.

In a variation of the implementation described above, second sets of image search results can be sent sequentially. For example, after the time t₅ in FIG. 2, the search engine again monitors for a signal of user interest in at least one image search result in the most recently provided second set of image search results, e.g., {SR2_{ba}}, or, alternatively, in any of the image search results. If the signal of user interest is received from the user device, then the search engine provides a subsequent second set of image search results to the user device to supplement the sets of image search results previously provided to the user device. For example, if the signal is based on a timeout and the timeout occurs, then the search engine 110 provides another second set of image search results {SR_{ba2}} at the timeout expiration, e.g., at time t₅+t_{timeoutwindow}.

### Example Search Result Processing

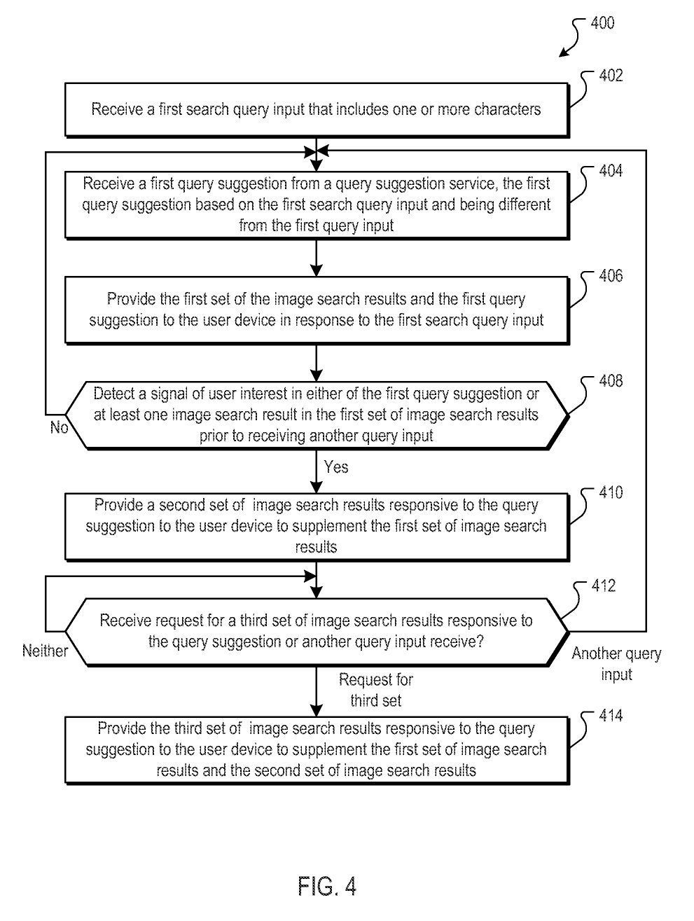

FIG. 4 is a flow diagram of an example process 400 for providing supplemental search results to a user device. The process 400 can be implemented in computer devices that are used to implement the search engine 110.

The process 400 receives, from a user device, a first search query input of one or more characters (402). For example, the search system 100 may receive the query input “ba.”

The process 400 receives a first query suggestion from a query suggestion service (404). The first query suggestion is based on the first search query input and is different from the first search query input. For example, for the query input “ba”, the query suggestion “backgrounds” may be received. Additional query suggestions may also be received as shown and described with reference to FIGS. 1-3C above.

The process 400 provides a first set of image search results and the first query suggestion to the user device (406). Each of the image search results references an image responsive to the first query suggestion.

The process 400, after providing the first set of image search results to the user device, monitors for a signal of user interest in either of the first query suggestion or at least one image search result in the first set of image search results (408). For example, a selection of the query suggestion, a non-navigational click in the view port in which the search results are displayed, a scrolling of the user interface in which the search results are displayed, or a period of time, e.g., three seconds, during which no additional query input is input at the user device, can each be interpreted as a signal of user interest in either the first query suggestion or the search results.

If a signal of user interest is not detected prior to receiving another query input, then the process 400 returns to 404, and repeats the subsequent steps. However, in response to detecting the signal of user interest prior to receiving another query input, the process 400 provides a second set of image search results responsive to the query suggestion to the user device to supplement the first set of image search results (410).

After providing the second set of search results, the process 400 waits to receive either another query input or a request for a third set of search results (412). If another query input is received, then the process 400 returns to 404, and repeats the subsequent steps. However, if a request for a third set of image search results responsive to the query suggestion is received, then the process 400 provides a third set of image search results to the user device in response to the request (414).

### Additional Implementation Features and Variations

In some implementations, at the search engine server, the first and second sets are determined in a first search operation, and the first set of search results is provided while the second set is cached. However, the third set of search results is not determined until the explicit user request is received. This conserves system resources while maintaining a relatively high cache hit rate as compared to initially caching the first, second and third sets of search results.

In some implementations, for each of the top N query suggestions (e.g., N=3 or the number of available rows in a viewport) for image search results, a row of image search results corresponding to the N^{th} query is shown. For example, with respect to FIG. 2, two rows of search results are available. The two top ranked search query suggestions are “backgrounds” and “babies.” Thus, the first row of search results SR1-1 . . . SR1-4 may be images of backgrounds, while the second row of image search results SR1-5 . . . SR1-8 may be images of babies.

### Additional Implementation Details

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus. The tangible program carrier can be computer-readable medium, such as a machine-readable storage device, a machine-readable storage substrate, a memory device, or a combination of one or more of them.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well: for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

What is claimed is:

1. A computer-implemented method, comprising:
receiving, from a user device, a first search query input comprising one or more characters;
receiving a first query suggestion from a query suggestion service, the first query suggestion having been generated based on the first search query input and being different from the first search query input;
receiving a first set of image search results, each of the image search results referencing an image responsive to the first query suggestion;
providing the first set of the image search results and the first query suggestion to the user device for display on the user device, in response to the first search query input;
after providing the first set of image search results to the user device, detecting, by a computer, a signal of user interest in either of the first query suggestion or at least one image search result in the first set of image search results, the detection of the signal of user interest occurring at or before a timeout expiration and being prior to receiving a second search query input subsequent to the first search query input; and
in response to detecting the signal of user interest and prior to receiving the second search query input subsequent to the first search query input, providing a second set of image search results to the user device for concurrent display with the first set of image search results previously provided to the user device, the first set of image search results being unmodified, and the second set of image search results being responsive to the first query suggestion.

2. The method of claim 1, wherein the first query suggestion is a highest-ranked query suggestion among a plurality of query suggestions generated based on the first search query input, and ranking of the plurality of query suggestions is based on relative submission frequencies of the plurality of query suggestions in a query log.

3. The method of claim 1, wherein providing the first set of the image search results and the first query suggestion to the user device comprises:
determining a size of available space for presenting image search results in a view port on the user device;
determining a first cardinality for the first set of image search results based on the size of the available space, the first cardinality being a value for which each image search result in the first set of image search results can be concurrently displayed in the available space; and
selecting a first cardinality of image search results responsive to the first query suggestion for inclusion in the first set of image search results.

4. The method of claim 3, wherein providing a second set of image search results to the user device comprises:
determining a second cardinality for the second set of image search results; and
selecting a second cardinality of additional image search results responsive to the first query suggestion for inclusion in the second set of image search results.

5. The method of claim 4, further comprising:
receiving, from the user device, a request for a third set of image search results responsive to the first query suggestion, the request being received after the providing the second set of image search results; and
providing the third set of image search results to the user device in response to the request for the third set of image search results.

6. The method of claim 5, wherein providing a third set of image search results to the user device comprises:
determining a third cardinality for the third set of image search results; and
selecting a third cardinality of additional image search results responsive to the first query suggestion for inclusion in the second set of image search results.

7. The method of claim 5, wherein the second cardinality is greater than the first cardinality, and the third cardinality is greater than the second cardinality.

8. The method of claim 1, wherein detecting a signal of user interest comprises receiving data from the user device indicating a movement of a cursor in the viewport displaying the first set of image search results.

9. The method of claim 1, wherein detecting a signal of user interest comprises receiving data from the user device indicating a scrolling event that results in a scrolling of a displayed first image search results in the viewport.

10. The method of claim 1, wherein detecting a signal of user interest comprises receiving data from the user device indicating a non-navigating user click received in a view port in which the first image search results are displayed.

11. The method of claim 1, further comprising providing one or more subsequent second sets of image search results, the providing of each of the one or more subsequent second sets of image search results comprising:
after providing any of the second sets of image search results to the user device, detecting another signal of user interest in at least one image search result in any of the first or second sets of image search results previously provided to the user device, the detection of the another signal of user interest being prior to receiving a second search query input subsequent to the first search query input; and
in response to detecting the another signal of user interest, providing a subsequent second set of image search results to the user device to supplement the sets of image search results previously provided to the user device, the subsequent second set of image search results being responsive to the first query suggestion.

12. A system, comprising:
a data processing apparatus; and
a computer memory apparatus in data communication with the data processing apparatus and storing instructions executable by the data processing apparatus and that upon such execution cause the data processing apparatus to perform operations comprising:
receiving, from a user device, a first search query input comprising one or more characters;
receiving a first query suggestion from a query suggestion service, the first query suggestion having been generated based on the first search query input and being different from the first search query input;
receiving a first set of image search results, each of the image search results referencing an image responsive to the first query suggestion;
providing the first set of the image search results and the first query suggestion to the user device for display on the user device in response to the first search query input;
after providing the first set of image search results to the user device, detecting a signal of user interest in either of the first query suggestion or at least one image search result in the first set of image search results, the detection of the signal of user interest occurring at or before a timeout expiration and being prior to receiving a second search query input subsequent to the first search query input; and
in response to detecting the signal of user interest and prior to receiving the second search query input subsequent to the first search query input, providing a second set of image search results to the user device for concurrent display with the first set of image search results previously provided to the user device, the first set of image search results being unmodified, and the second set of image search results being responsive to the first query suggestion.

13. The system of claim 12, wherein the first query suggestion is a highest-ranked query suggestion among a plurality of query suggestions generated based on the first search query input, and ranking of the plurality of query suggestions is based on relative submission frequencies of the plurality of query suggestions in a query log.

14. The method of claim 12, wherein providing the first set of the image search results and the first query suggestion to the user device comprises:
determining a size of available space for presenting image search results in a view port on the user device;
determining a first cardinality for the first set of image search results based on the size of the available space, the first cardinality being a value for which each image search result in the first set of image search results can be concurrently displayed in the available space; and
selecting a first cardinality of image search results responsive to the first query suggestion for inclusion in the first set of image search results.

15. The system of claim 14, wherein providing a second set of image search results to the user device comprises:
determining a second cardinality for the second set of image search results; and
selecting a second cardinality of additional image search results responsive to the first query suggestion for inclusion in the second set of image search results.

16. The system of claim 15, wherein the operations further comprise:
receiving, from the user device, a request for a third set of image search results responsive to the first query suggestion, the request being received after the providing the second set of image search results; and
providing the third set of image search results to the user device in response to the request for the third set of image search results.

17. The system of claim 16, wherein providing a third set of image search results to the user device comprises:
determining a third cardinality for the third set of image search results; and
selecting a third cardinality of additional image search results responsive to the first query suggestion for inclusion in the second set of image search results.

18. The system of claim 16, wherein the second cardinality is greater than the first cardinality, and the third cardinality is greater than the second cardinality.

19. The system of claim 12, wherein detecting a signal of user interest comprises receiving data from the user device indicating a movement of a cursor in the viewport displaying the first set of image search results.

20. The system of claim 12, wherein detecting a signal of user interest comprises receiving data from the user device indicating a scrolling event that results in a scrolling of a displayed first image search results in the viewport.

21. The system of claim 12, wherein detecting a signal of user interest comprises receiving data from the user device indicating a non-navigating user click received in a view port in which the first image search results are displayed.

22. The system of claim 12, wherein the operations further comprise:
providing one or more subsequent second sets of image search results, the providing of each of the one or more subsequent second sets of image search results comprising:
after providing any of the second sets of image search results to the user device, detecting another signal of user interest in at least one image search result in any of the first or second sets of image search results previously provided to the user device, the detection of the another signal of user interest being prior to receiving a second search query input subsequent to the first search query input; and
in response to detecting the another signal of user interest, providing a subsequent second set of image search results to the user device to supplement the sets of image search results previously provided to the user device, the subsequent second set of image search results being responsive to the first query suggestion.

23. A computer memory apparatus storing instructions executable by a data processing apparatus and that upon such execution cause the data processing apparatus to perform operations comprising:
receiving, from a user device, a first search query input comprising one or more characters;
receiving a first query suggestion from a query suggestion service, the first query suggestion having been generated based on the first search query input and being different from the first search query input;
receiving a first set of image search results, each of the image search results referencing an image responsive to the first query suggestion;
providing the first set of the image search results and the first query suggestion to the user device for display on the user device, in response to the first search query input;
after providing the first set of image search results to the user device, detecting a signal of user interest in either of the first query suggestion or at least one image search result in the first set of image search results, the detection of the signal of user interest occurring at or before a timeout expiration and being prior to receiving a second search query input subsequent to the first search query input; and
in response to detecting the signal of user interest prior to receiving the second search query input subsequent to the first search query input, providing a second set of image search results to the user device for concurrent display with the first set of image search results previously provided to the user device, the first set of image search results being unmodified, and the second set of image search results being responsive to the first query suggestion.

24. The computer memory apparatus of claim 23, wherein the first query suggestion is a highest-ranked query suggestion among a plurality of query suggestions generated based on the first search query input, and ranking of the plurality of query suggestions is based on relative submission frequencies of the plurality of query suggestions in a query log.

25. The computer memory apparatus of claim 23, wherein providing the first set of the image search results and the first query suggestion to the user device comprises:
determining a size of available space for presenting image search results in a view port on the user device;
determining a first cardinality for the first set of image search results based on the size of the available space, the first cardinality being a value for which each image search result in the first set of image search results can be concurrently displayed in the available space; and
selecting a first cardinality of image search results responsive to the first query suggestion for inclusion in the first set of image search results.

26. The computer memory apparatus claim 25, wherein providing a second set of image search results to the user device comprises:
determining a second cardinality for the second set of image search results; and
selecting a second cardinality of additional image search results responsive to the first query suggestion for inclusion in the second set of image search results.

27. The computer memory apparatus of claim 26, the operations further comprising:
receiving, from the user device, a request for a third set of image search results responsive to the first query suggestion, the request being received after the providing the second set of image search results; and
providing the third set of image search results to the user device in response to the request for the third set of image search results.

28. The computer memory apparatus of claim 27, wherein providing a third set of image search results to the user device comprises:
determining a third cardinality for the third set of image search results; and
selecting a third cardinality of additional image search results responsive to the first query suggestion for inclusion in the second set of image search results.

29. The computer memory apparatus of claim 28, wherein the second cardinality is greater than the first cardinality, and the third cardinality is greater than the second cardinality.
